(19) United States
(12) Patent Application Publication
(10) Pub. No.: US 2018/0102051 A1
(43) Pub. Date: Apr. 12, 2018

(54) ROADWAY INCIDENT VIDEO REPORTING SYSTEM AND PROCESSES

(71) Applicant: Hiral Suthar, Newark, CA (US)

(72) Inventor: Hiral Suthar, Newark, CA (US)

(21) Appl. No.: 15/725,495

(22) Filed: Oct. 5, 2017

Related U.S. Application Data
(60) Provisional application No. 62/405,720, filed on Oct. 7, 2016.

(51) Int. Cl. G08G 1/09; H04N 5/247; H04N 5/765; B60R 11/04; G06Q 50/26

(52) U.S. Cl. CPC G08G 1/094; H04N 5/247; H04B 1/3816; B60R 11/04; G06Q 50/26; H04N 5/765

(57) ABSTRACT

A roadway incident video reporting system and processes for reporting a roadside incident and providing a video captured of the roadside incident are disclosed. In some embodiments, the roadway incident video reporting system provides a way to allow individuals to capture video of roadside incidents using two dash cameras in a vehicle and a memory stick that stores video captured by the dash cameras, and report the roadside incidents to the DMV.

### CLAIM OF BENEFIT TO PRIOR APPLICATION

This application claims benefit to U.S. Provisional Patent Application 62/405,720, entitled “ROADWAY INCIDENT VIDEO REPORTING SYSTEM,” filed Oct. 7, 2016. The U.S. Provisional Patent Application 62/405,720 is incorporated herein by reference.

### BACKGROUND

Embodiments of the invention described in this specification relate generally to road safety systems, and more particularly, to a roadway incident video reporting system and processes for reporting a roadside incident and providing a video captured of the roadside incident.

Drivers and passengers of vehicles on roadways, highways, streets, avenues, and other motor vehicle pathways (hereinafter referred to collectively and individually as “roadways”) are routinely exposed to dangerous driving conditions. Some of the dangerous driving conditions relate to the physical structure of the roadways, while other dangerous driving conditions relate to other vehicles traveling on the roadways. The types of dangerous driving conditions that occur daily include, without limitation, swerving a car into another lane without giving a signal, incidents of road rage and careless indifference to others on the roadway, hit and run incidents, disregard for the rules of the road, especially the rules promulgated by a State Department of Motor Vehicles (DMV), and many more dangerous roadway driving conditions.

A number of existing roadway safety systems are in place to protect drivers and passengers in vehicles. For instance, unsafe roads are labeled with appropriate warning signage where possible, and police departments typically patrol roadways for dangerous drivers or unsafe vehicles. However, when vehicles are being driven in ways that cause dangerous driving conditions for others, the typical roadway safety systems are often insufficient to remedy the situation because all too often driving safety issues arise spontaneously and within an instance of time. Unless police happen to be patrolling the roadway within a visible distance from a dangerous driver of a vehicle, it is unlikely that the reckless driver will be caught. There are cameras on traffic light signals to capture red light violations, but the scope of roadway safety that these cameras provide is so limited to be not useful in dealing with the many types of dangerous roadway incidents or conditions that are seemingly omnipresent in today's roadways.

As noted above, there are police officers patrolling many roadways most of the time. However, the police cannot patrol every roadway completely and at all times. On the other hand, there are typically more vehicles being driven along a roadway wherever dangerous roadway driving incidents occur. Many vehicles today have dash cameras that people use for their own needs. However, the dash cameras might be considered a road safety resource that is underutilized with respect to reducing roadway driving dangers. As they typically are configured with at least a front camera and a back camera, drivers could provide a great road safety element to the existing systems, while also maintaining use of the dash cameras for their own needs.

Therefore, what is needed is a way to allow individuals to capture video of roadside incidents or violations that occur regularly but which are vastly unreported, and a way to report the incidents and violations, along with the captured video, to the DMV.

### BRIEF DESCRIPTION

A novel roadway incident video reporting system and processes for reporting a roadside incident and providing a video captured of the roadside incident are disclosed. In some embodiments, the roadway incident video reporting system and processes for reporting a roadside incident and providing a video captured of the roadside incident provide ways to allow individuals, such as drivers of vehicles, to capture video of roadside incidents using two dash cameras in a vehicle and a memory stick that stores video captured by the dash cameras, and report the roadside incidents to the DMV.

The preceding Summary is intended to serve as a brief introduction to some embodiments of the invention. It is not meant to be an introduction or overview of all inventive subject matter disclosed in this specification. The Detailed Description that follows and the Drawings that are referred to in the Detailed Description will further describe the embodiments described in the Summary as well as other embodiments. Accordingly, to understand all the embodiments described by this document, a full review of the Summary, Detailed Description, and Drawings is needed. Moreover, the claimed subject matters are not to be limited by the illustrative details in the Summary, Detailed Description, and Drawings, but rather are to be defined by the appended claims, because the claimed subject matter can be embodied in other specific forms without departing from the spirit of the subject matter.

### BRIEF DESCRIPTION OF THE DRAWINGS

Having thus described the invention in general terms, reference is now made to the accompanying drawings, which are not necessarily drawn to scale, and which show different views of different example embodiments, and wherein:

FIG. 1 conceptually illustrates a roadway incident video reporting process for using roadway incident video reporting system hardware in a vehicle to capture video while the vehicle is operating and to report any roadway incidents captured on video in some embodiments.

FIG. 2 conceptually illustrates a roadway incident video capturing process for capturing video data by a dash camera system of a vehicle or a mobile device with a mobile app and allowing a user, such as a driver of the vehicle, to specify whether to retain video data locally or provide to host by web application in some embodiments.

FIG. 3 conceptually illustrates an internal view of an automobile hardware camera system in some embodiments used to capture, save, and provide video data to report roadway incidents to a responsible agency.

FIG. 4 conceptually illustrates a front view of an automobile hardware camera system in some embodiments used to capture, save, and provide video data to report roadway incidents to a responsible agency.

FIG. 5 conceptually illustrates a bottom view of an automobile hardware camera system in some embodiments used to capture, save, and provide video data to report roadway incidents to a responsible agency.

FIG. 6 conceptually illustrates a network architecture of a roadway incident video capturing and reporting system in some embodiments.

FIG. 7 conceptually illustrates an electronic system with which some embodiments of the invention are implemented.

### DETAILED DESCRIPTION

In the following detailed description of the invention, numerous details, examples, and embodiments of a novel roadway incident video reporting system and processes for reporting a roadside incident and providing a video captured of the roadside incident are described. In this description certain trademarks, word marks, and/or copyrights are referenced, including Wi-Fi®, which is a registered trademark of Wi-Fi Alliance, and Bluetooth®, which is a registered trademark owned by Bluetooth SIG, Inc. However, it will be clear and apparent to one skilled in the art that the roadway incident video reporting system is not limited to the embodiments set forth and that the roadway incident video reporting system and processes for reporting a roadside incident and providing a video captured of the roadside incident can be adapted for any of several applications.

Some embodiments of the invention include a novel roadway incident video reporting system and processes for reporting a roadside incident and providing a video captured of the roadside incident. In some embodiments, the roadway incident video reporting system and processes for reporting a roadside incident and providing a video captured of the roadside incident provide ways to allow individuals, such as drivers of vehicles, to capture video of roadside incidents using two dash cameras in a vehicle and a memory stick that stores video captured by the dash cameras, and report the roadside incidents to the DMV.

As stated above, people are routinely exposed to dangerous roadway incidents and/or reckless or careless driving. The existing roadway safety systems lack the mobility and presence needed to reduce the problems that result from the roadway dangers. Many vehicles are equipped with dash cameras, but they are underutilized in terms of general roadway safety (applying their use mostly for the benefit of a single driver/vehicle, instead of the common good). Therefore, people who are drivers or passengers are constantly faced with dangerous situations which will not subside unless there is some way to have a completely mobile networked video system that can tap into DMV for reporting of irregular or illegal driving, while also reporting other dangerous roadway conditions.

Embodiments of the roadway incident video reporting system and processes for reporting a roadside incident and providing a video captured of the roadside incident described in this specification solve such problems by utilizing two dash cameras and a memory stick or memory device to capture video of roadway incidents. In some embodiments, the roadway incident video reporting system includes an implementation of a web application whereby drivers can subscribe by using their registered vehicles, such that the web application will help them record and save all video data captured by their car in their respective subscribed account. This web application, in some embodiments, also reviews the video data from drivers and filters roadway incidents in the video data to identify all respective violations captured by them. The web application is accessible via any electronics devices (computing device and mobile devices, etc.), including cellphones, computer/laptops, tablets, etc., and in some embodiments, the devices with the web application can be used in place of dash cameras to capture video data, when the devices include on-board video capture devices, embedded cameras, etc.

The roadway incident video reporting system and processes for reporting a roadway incident and providing a video captured of the roadway incident, therefore, help people to capture all roadside violations, accidents or many other incidents as video data, and to thereafter save and utilize the video data as needed. For instance, the user can save the video data for an insurance claim, or can report roadway incidents by providing the video data to the DMV. In some embodiments, the dash cameras are factory installed dash cameras. For instance, many of today's vehicles come equipped with one or more dash cameras, installed by the original vehicle manufacturer. In some embodiments, the dash cameras are retrofit dash cameras installed into the vehicle after market. For example, a vehicle without factory installed dash cameras can benefit from the roadway incident video reporting system by installing commercially available dash cameras. When one or more dash cameras are needed, auto garages and auto details can work to retrofit install them in existing vehicles. With one at the front of a vehicle and another at the back of the vehicle, these dash cameras are able to capture all driving videos continuously while the vehicle is on the road and drivers can save the videos as needed and/or report any kind of roadway incident to the DMV. Also, instead of a dash cam, a driver could simply use a mobile device with an on-board video capture device (e.g., a smartphone, a tablet computing device, etc.). When the mobile device includes a mobile web application capable of connecting to the web service at the DMV (or at a third party administrator on behalf of the DMV), then the driver can just use the mobile device to capture video data and transmit the video data to the driver's user account at the host site of the DMV via the mobile web application. In addition, some embodiments of the web application include smart review of the video data and separates the important video data related to important roadway incidents. This is important given the volume of data that can be captured by the driver's devices, since it allows the DMV to focus only on the critical video related directly to possible roadway infractions that are able to be cited. At that point, the DMV can issue a citation if the video provides enough proof.

Embodiments of the roadway incident video reporting system and processes for reporting a roadside incident and providing a video captured of the roadside incident described in this specification differ from and improve upon currently existing options. In particular, some embodiments of the roadway incident video reporting system and processes for reporting a roadside incident and providing a video captured of the roadside incident differ by supporting an overall mobile distribution which provides roadway incident coverage that is practically omnipresent. The existing roadway safety system includes spotty roadway incident coverage by law enforcement (i.e., police patrolling of roadways). Specifically, there are police officers available at many places on the road, but they are not at all places at all times. As such, the existing roadway safety system based on police patrolling of the roadways is inadequate for today's traffic realities. In contrast, the widespread use of dash cameras in vehicles that drive the roadways makes the roadway incident video reporting system available from almost all places of the roadway and at almost all times. Similarly, drivers with insufficient dash camera coverage may use mobile devices with the web application installed to capture and transmit video data or roadway incidents. Furthermore, a subscriber driver account is possible that ensures that video captured by the hardware system in a driver's vehicle (or their mobile device with user-registered and authenticated web application installed) is a true representation of the roadway incidents as occurred proximate to the driver's own vehicle and the time period during which the video was captured (as confirmed by time-stamp meta-data). Also, there are car dash cameras which are available for anyone to use for their own protection, but the cameras might not always be on. Other roadway safety systems include cameras on traffic light signals (e.g., “red light cameras”) to capture traffic light violations only, but not other violations. Thus, the existing roadway safety systems are inadequate for dealing with the incidents that routinely arise and put most drivers and passengers in physical danger.

In addition, embodiments of the roadway incident video reporting system and processes for reporting a roadside incident and providing a video captured of the roadside incident improve upon the currently existing options by supporting expanded memory options to save video data and support for automatic transfer of video data to a cloud server hosted by the DMV (or a third party representing the DMV), where the video data is transferred contemporaneously with the video being captured by the dash camera(s) and/or mobile device with web application installed. In particular, all memory devices have some limitations to saving data and the existing dash cameras for personal usage of drivers or car owners include such limited capacity memory storage devices, thereby limiting their use to a capped storage capacity dictated by the embedded memory storage of the dash camera. Yet, having a SIM card slot allows for any wireless carrier (e.g., TMobile, AT&T, Verizon, etc.) to provide wireless connectivity (e.g., 4G type data connectivity) which obviates the need for expansion of data capacity since the wireless data connectivity would ultimately transmit all the video data to the remote host contemporaneously with capturing the video, thereby resolving any memory capacity issues which may otherwise have arisen.

While some embodiments of the roadway incident video reporting system and processes for reporting a roadside incident and providing a video captured of the roadside incident overcome physical memory limitations, in many scenarios, limitations will be present or imposed. For example, some drivers may only deploy a single limited memory storage device, or the DMV may limit the storage capacity of individual driver accounts who report roadway incidents, limiting the amount of video data that the driver can upload. In some embodiments, the roadway incident video reporting system is able to handle such imposed limits. For instance, when video data is able to be automatically transferred to the DMV host site, then in some embodiments, the memory is also automatically refreshed so that memory capacity is never reached, but the video data on the DMV host site may be reviewed automatically to filter and identify relevant roadway incidents in the video data on the subscriber's account, thereby eliminating video data with normal driving conditions (e.g., without any observable roadway incidents).

More specifically, many of the existing in-built cameras have some limitation of memory capacity so users should regularly download and save important videos. Consequently, in some embodiments of the roadway incident video reporting system there will be a memory limitation in a subscriber driver's web application and/or the driver's DMV host (cloud-based) account. Accordingly, the possibility of abuse is reduced/removed because drivers will be dissuaded from reporting everything (real or frivolous), especially things which they feel are normal safety issues best left to the judgment of individual drivers. Moreover, instead of allowing drivers to misuse this DMV link and file some random videos, drivers have a step to contemplate which is a time period during which the driver may have to shrink their videos to just what they are reporting. Again, this reduces the overburdening concern with respect to the DMV, as drivers are not likely to report frivolous matters when the amount of work the driver must complete prior to informing the DMV is substantial. In addition, the roadway incident video reporting system can be limited by memory having some saving limitation so it will keep some time to live (TTL) parameter that limits the data saved for reporting to a period of time before self-destructing or allowing new data to overwrite old data as the new video captures start feeding the memory.

Moreover, there can be user account settings which limit memory for reporting purposes. In some embodiments, the drivers will be able to manage their subscriber driver DMV accounts via the web application so as to delete old reports and make space for their new report videos.

In some embodiments, a video trimming utility allows drivers to shrink their videos to a sequence of video frames that cover just the roadway incident being reported. For instance, the dash camera in a driver's car may capture video during the entire journey, but the driver may wish to report only an incident that occurred near the end of the journey. In this case, the video trimming utility or any of several open source video tools can be used to select the sequence of frames to be submitted in conjunction with the roadway incident report.

In some embodiments, if the DMV/Government agrees, drivers can be offered some bonus points or some tax benefit for submission of valid roadway incident reports.

Drivers can misuse the ability to file video reports with the DMV such as by submitting frivolous roadway incident reports. Such cases are addressed in any of several manners, including via a notification system whereby a notification on each user's account indicates whether the system was misused in relation to user-submitted roadway incident report and corresponding video. In some egregious cases, the user may face punitive results, such as getting a citation for filing a frivolously roadway incident report/video. Repeat offenders can further be limited for each successive frivolous roadway incident reported, to a point where the user's account for reporting roadway incidents may be suspended or revoked permanently.

Several more detailed embodiments are described in the sections below. Section I describes some processes for reporting a roadway incident and providing a video captured of the roadway incident. Section II describes examples of an automobile hardware camera system used in a roadway incident reporting system. Section III describes a network architecture of a roadway incident video capturing and reporting system. Section IV describes an electronic system that implements some embodiments of the invention.

### I. Processes for Reporting a Roadway Incident and Providing a Video Captured of the Roadway Incident

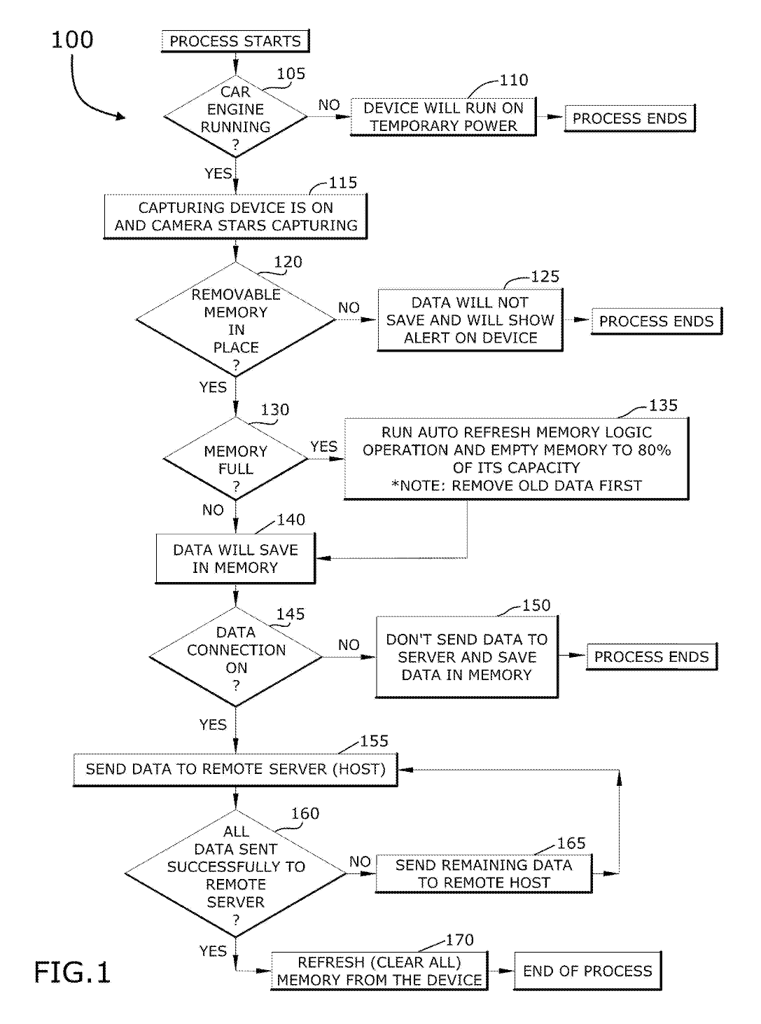

By way of example, FIG. 1 conceptually illustrates a roadway incident video reporting process 100 for using roadway incident video reporting system hardware in a vehicle to capture video while the vehicle is operating and to report any roadway incidents captured on video. The roadway incident video reporting process 100 of some embodiments is implemented as a roadway incident video reporting program that runs on a processor. For example, the roadway incident video reporting program may run on a processor embedded in the roadway incident video reporting system hardware (also referred as the “device” in the description of this figure) used in a car that a driver is operating.

In some embodiments, the roadway incident video reporting process 100 starts by determining (at 105) whether the car engine is running. When the roadway incident video reporting process 100 negatively determines that the car engine is not running, then the device will run on temporary power (at 110), in which case the roadway incident video reporting process 100 ends. On the other hand, when the roadway incident video reporting process 100 affirmatively determines that the car engine is running, then the device is powered on and the roadway incident video reporting process 100 starts capturing (at 115) video.

Next, the roadway incident video reporting process 100 of some embodiments determines (at 120) whether a removable memory storage device is in place. The removable memory storage device is in place when the memory is placed in a memory slot of the roadway incident video reporting system hardware. Therefore, when the roadway incident video reporting process 100 negatively determines that the removable memory storage device is not in place, the video data being captured will not be saved and the roadway incident video reporting process 100 shows (at 125) an alert on the device. Since the video being captured by the dash cameras is not being saved/stored, the roadway incident video reporting process 100 ends.

On the other hand, when the roadway incident video reporting process 100 affirmatively determines that a removable memory storage device in in place, then the roadway incident video reporting process 100 determines (at 130) whether the memory is full. When the memory is not full, the roadway incident video reporting process 100 of some embodiments saves (at 140) the data in memory of the removable memory storage device. However, when the memory is affirmatively determined to be full, the roadway incident video reporting process 100 of some embodiments runs auto refresh (at 135) of the memory, emptying the memory a certain amount to free up some space from the total memory. For instance, the auto refresh memory logic operation may empty 80% of the capacity of the memory storage device, or in some instances the auto refresh memory logic operation may empty 20% of the data to free up some space, leaving approximately 80% of the capacity of the memory storage device in place. In some embodiments, the auto refresh of the memory removes old/existing data and stores in any other available memory or backup. After refreshing the memory and emptying some of the data from the total memory, the roadway incident video reporting process 100 then saves (at 140) the data in memory, as noted above.

In some embodiments, the roadway incident video reporting process 100 next determines (at 145) whether a data connection to a remote server (or “host server”) is available and active (or “on”). When the roadway incident video reporting process 100 negatively determines that there is no data connection to the remote server, then the captured video data will not be sent (at 150) to the remote server, but instead is only saved locally in memory on the removable memory storage device. Note that the driver can upload the video data to the DMV (or rather, the remote server hosted by the DMV or another entity hosting the remote server) later, when a connection to the remote host is available (e.g., a WiFi connection, internal 4G type data connectivity, etc.). Then the roadway incident video reporting process 100 ends.

On the other hand, when the roadway incident video reporting process 100 affirmatively determines that there is an active data connection to the remote server (host), then the captured video data is sent (at 155) to the remote server (host). For example, the video data saved on the host may be a server of the DMV, and the video data may include one or more roadway incidents. After the video data is sent to the remote host, the roadway incident video reporting process 100 of some embodiments determines (at 160) whether all of the video data has been successfully sent to the remote server. When there is more video data to transmit to the remote host, then the roadway incident video reporting process 100 continues to send (at 165) the video data to the remote server. The roadway incident video reporting process 100 continues to check whether the video data has been successfully sent to the remote server until, when the video data is determined to be successfully sent to the remote server, the roadway incident video reporting process 100 refreshes (at 170) the memory from the removable memory storage device. In some embodiments, the roadway incident video reporting process 100 refreshes the memory storage device by clearing all the video data from the memory storage device. Then the roadway incident video reporting process 100 ends.

The roadway incident video reporting process 100 of the present disclosure generally works by the above-listed steps, in the order listed, so the driver can capture video while driving a vehicle on a common roadway and report any roadway incidents to the DMV by sending the video data to the remote server hosted by the DMV. However, a person of ordinary skill in the relevant art will recognize that different embodiments of the roadway incident video reporting process 100 can include different steps or a different order of steps and still carry out the essential function of the roadway incident video reporting process. For instance, in some embodiments, the roadway incident video reporting process includes a step for allowing the driver to decide whether to delete existing video on the removable memory storage device when available memory is low, and allows the driver to configure an amount of data to free up.

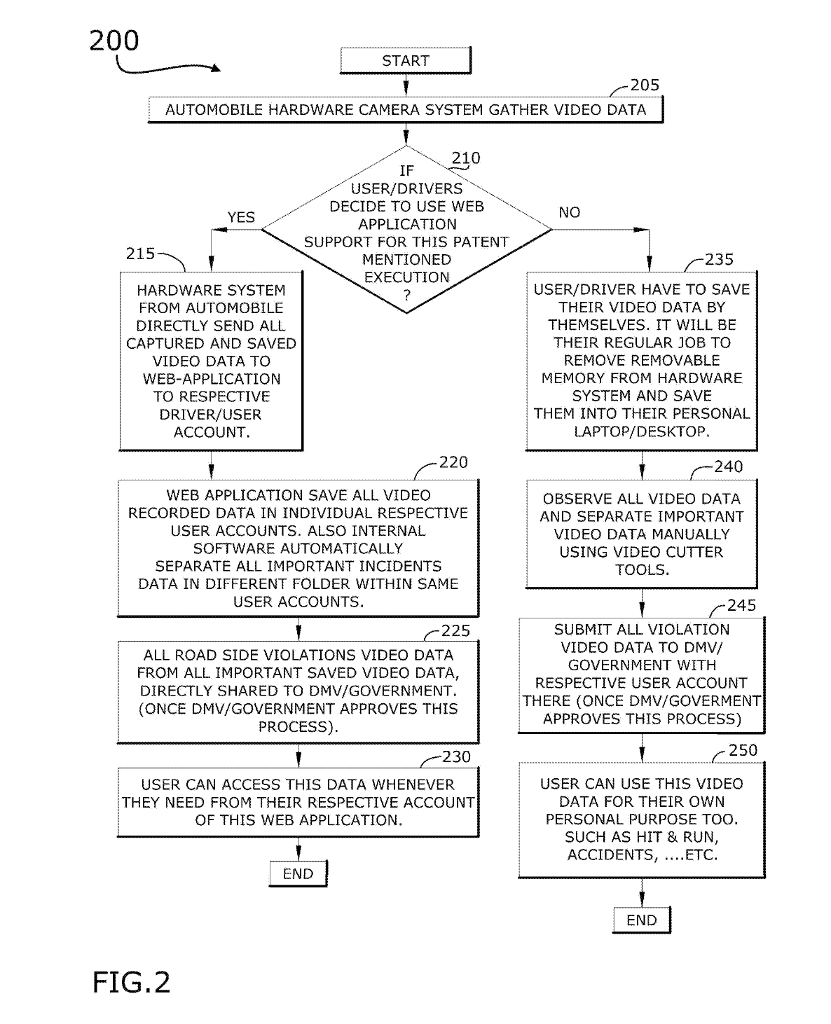

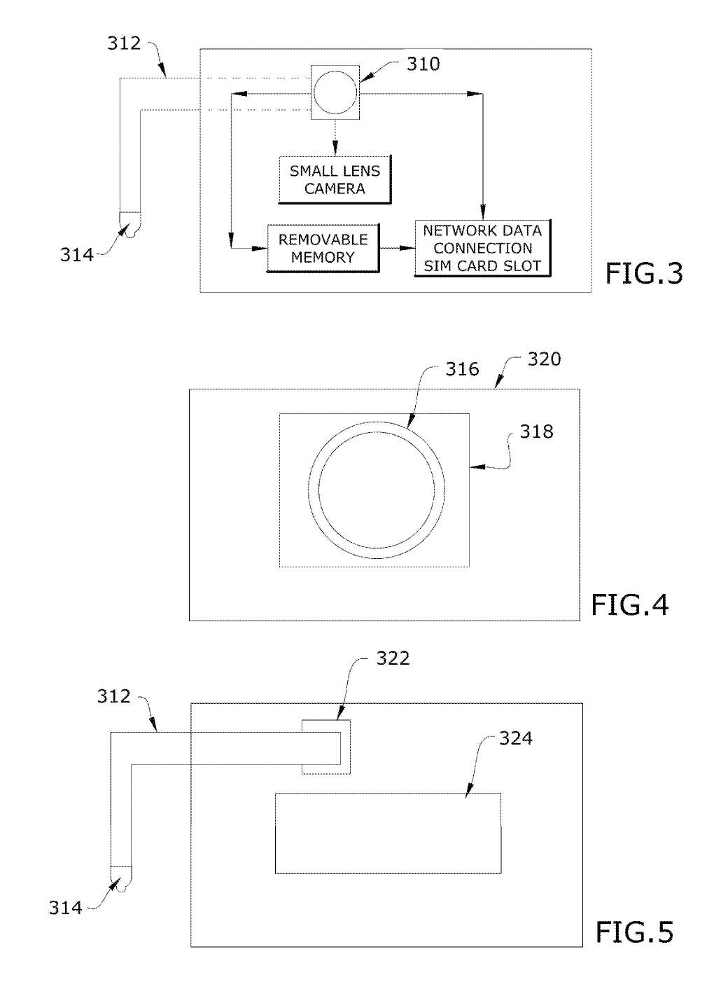

Turning to another example, FIG. 2 conceptually illustrates a roadway incident video capturing process 200 for capturing video data by a dash camera system of a vehicle or a mobile device with a mobile app and allowing a user, such as a driver of the vehicle, to specify whether to retain video data locally or provide to host by web application. The roadway incident video capturing process 200 of some embodiments is implemented as a roadway incident video capturing program that runs on a processor. For example, the roadway incident video capturing program may run on a processor embedded in the roadway incident video reporting system hardware (also referred as the “automobile hardware camera system” and the “hardware system” in the description of this figure) used in the vehicle that the driver is operating or the roadway incident video capturing program may be a mobile web application that runs on a processor of a mobile device which the driver uses to capture video. Furthermore, the roadway incident video reporting system hardware may include on-board communication devices that provide wireless communication service (e.g., 3G, 4G, 5G type wireless communication connectivity, thereby allowing for all captured video data to be transmitted to the remote host, or cloud service, in the respective user account). Additionally, from the perspective of mobile device usage, the driver may use multiple mobile devices, each with the mobile web application implementation of the roadway incident video capturing program, with one mobile device capturing video out the front windshield, for example, and the other mobile device capturing video out the back. A person skilled in the relevant art would appreciate that the driver may mix and match the hardware devices, such that a front-facing (or alternatively, a back-facing) dash cam is part of roadway incident video reporting system hardware, while the second recording device is a mobile device, such as a smartphone, with the mobile web application running. Thus, for purposes of describing this figure, the automobile hardware camera system is understood to include one or more roadway incident video reporting system hardware device(s) (such as those described further below, by reference to FIGS. 3-5) and/or one or more mobile device(s) (such as a smartphone, a tablet computing device, etc.), with on-board video capture device.

In some embodiments, the roadway incident video capturing process 200 starts with the automobile hardware camera system gathering (at 205) video data. Next, the roadway incident video capturing process 200 determines (at 210) whether the user or driver has decided to use the web application that supports connection to the web service on the remote host. When the driver has decided to use the web application, then the roadway incident video capturing process 200 sends (at 215) all captured video data and saved video data to the web service via the web application and driver account on the remote host (e.g., DMV) directly from the hardware system in the automobile. Next, the web service (via the web application) saves (at 220) all the video data captured and saved (and received) in individual user accounts for each driver associated with a user account on the remote host (e.g., DMV). Internal software running on the web application and/or the web service process running on the remote server may automatically separate the video data of all important roadway incidents. In some cases, the video data is separated for important roadway incidents to be stored in a different folder in a file system associated with the user account. After the video data is saved, the roadway incident video capturing process 200 of some embodiments shares (at 225) the important, separated video data of all the important roadside incidents or violations with the DMV or government agency, as provided by the government. The user/driver can access (at 230) the video data shared with the DMV or government agency at any time. For example, whenever the user/driver needs the video data, the user/driver can use the web application to access the video data. Then the roadway incident video capturing process 200 ends.

On the other hand, when the roadway incident video capturing process 200 determines (at 210) that the driver has decided not to use the web application, then the user/driver saves (at 235) the captured video data. In some embodiments, the saved video data will automatically be transmitted to the user account at the host (cloud server), such as when there is support for a wireless communication/connectivity standard (e.g., 3G, 4G, 5G, etc.). In some other embodiments, where there is no connectivity or when the driver does not enable such connectivity, then the driver will need to take proactive steps to remove important video data associated with important roadway incidents from the removable memory storage device. For example, the driver/user can remove all the video data captured during a travel trip and save it on a computing device, such as a laptop computer, a desktop computer, etc., or save it in a cloud storage space. In such cases, the computing device (e.g., laptop, desktop, etc.) may also have the web application installed or may use a web browser to connect to the cloud service to upload the video data into the user's account.

Next, the roadway incident video capturing process 200 transitions to the next step (at 240) where the driver/user observes all the video data and proactively separates important video data associated with important roadway incidents. The driver/user can use video editing and trimming tools to separate important video data when the video editing and trimming tools are available. After saving and separating the video data, the roadway incident video capturing process 200 transitions to the next step (at 245) where the driver/user submits all violation or roadway incident video data to the DMV or other government agency. The driver/user submits the video data in relation to the respective user account of the driver/user. Then the user can use the saved video data (at 250) for their own personal purposes, such as might be needed in the case of a collision or other accident (e.g., hit & run, accidents, etc.). Then the roadway incident video capturing process 200 ends.

The roadway incident video capturing process 200 of the present disclosure generally works by the above-listed steps, in the order listed, so the user (or driver) can configure how the captured video data is to be handled once the hardware obtains the video data, with one option being direct uploading and providing to the DMV from the hardware system and another option being capturing and saving the video data on the removable memory storage device, but manually (or proactively) handling the video data at a later time by the user/driver. However, a person of ordinary skill in the relevant art will recognize that different embodiments of the process can include different steps for different options or a different order of steps and still carry out the essential function of how to handle the captured and saved video data. For instance, in some embodiments, the roadway incident video capturing process 200 may include an option for capturing and saving the video data on the removable memory storage device and waiting until a recognized WiFi connection is detected to upload the video data to the DMV hosted server.

### II. Automobile Hardware Camera System

The roadway incident video reporting system of the present disclosure may be comprised of the following elements. This list of possible constituent elements is intended to be exemplary only and it is not intended that this list be used to limit the roadway incident video reporting system of the present application to just these elements. Persons having ordinary skill in the art relevant to the present disclosure may understand there to be equivalent elements that may be substituted within the present disclosure without changing the essential function or operation of the roadway incident video reporting system.

1. Front dash camera

2. Back dash camera

3. Memory device (such as a memory stick in-build into a motor vehicle)

4. Video wiring that connects the dash cameras to the memory device to save video as it is being captured

The various elements of the roadway incident video reporting system of the present disclosure may be related in the following exemplary fashion. It is not intended to limit the scope or nature of the relationships between the various elements and the following examples are presented as illustrative examples only. In some embodiments, the dash cameras are built-in cameras (installed by the vehicle manufacturer and sold with new vehicle). In some embodiments, the dash cameras are installed into a vehicle (secondary market vehicle installations of dash cameras). In the case where the dash cameras are installed into the vehicle after market via secondary market, the vehicle owner can either buy two dash cameras to use in their car, have them installed in the car (say, at an auto garage or auto detailer), and use the dash cameras on a daily basis the same as factory installed dash cameras. In some of these cases, existing memory stick options (e.g., USB port in a vehicle) can be utilized to store the captured videos. In other cases, memory stick or memory devices can be installed in the vehicle and/or connected to the cameras. Whatever memory device configuration a vehicle owner has, the driver will have the ability to take out the memory stick from front dashboard of the car to download the captured video data or will be able to connect to the memory device (e.g., via USB cable) and download the video data to some connected computing device.

By way of example, FIG. 3 conceptually illustrates an internal view of an automobile hardware camera system used to capture, save, and provide video data to report roadway incidents to a responsible agency. As shown in this figure, the automobile hardware camera system includes a power supply 310 with limited powers saver, an external power supply cable 312, and a power plug 314 to connect to a power source of the automobile for power supply. The power supply 310 provides power to a small lens camera, a removable memory storage device, and a network data connection SIM card in a card slot.

Now turning to another example, FIG. 4 conceptually illustrates a front view of the automobile hardware camera system used to capture, save, and provide video data to report roadway incidents to a responsible agency. As shown in this figure, the automobile hardware camera system includes a camera lens 316, a transparent lens protection layer 318, and a sturdy package 320 for the automobile hardware camera system. As noted above by reference to FIG. 3, the power supply 310 provides power to the camera lens 316 for capturing video data while the driver is operating the vehicle.

In another example, FIG. 5 conceptually illustrates a bottom view of the automobile hardware camera system used to capture, save, and provide video data to report roadway incidents to a responsible agency. As shown in this figure, the automobile hardware camera system includes an external connection 322 to the automobile hardware camera system and a facility to connect 324 to an external surface of any automobile. The automobile hardware camera system also includes the external power supply cable 312 and the power plug 314 to connect to a power source of the automobile for power supply.

The roadway incident video reporting system of the present disclosure generally works by dash cameras and memory devices to capture and save all videos while a vehicle is running. Many car companies already have built-in dash cameras in their vehicles with the ability of having a memory stick on the front dashboard. This memory stick is easy to remove and download/save all captured videos as per needed. Also, the DMV of a state or government may deploy systems to allow all valid drivers to report any anonymous incidents on the road, such as vehicles recklessly swerving between lanes without giving any signal or indication of intentions to change lanes, various fits of road rage, the many occurrences of hit and run collisions, or otherwise blatantly, recklessly, or carelessly disregarding the rules of the road as specified by the DMV for all drivers, and many more. With these reports and corroborating videos, the DMV can give citations to respective car owners if they violated the DMV rules. Many state DMVs already allow drivers to create online account with saved information of addresses, licenses, car-registration, etc. The present roadway incident video reporting system expands this existing online driver account management with the addition of some amount of memory for each user account so that valid drivers can provide such roadway incident reports and the corresponding video files.

The roadway incident video reporting system of the present disclosure will benefit drivers and passengers everywhere. In addition, the roadway incident video reporting system will benefit many aspects of police patrolling and rescue/fire incidents where ambulances and/or fire trucks must be called for emergencies. In such drastic emergency type situations, video that is captured of the events surrounding the emergency can be highly beneficial to the efforts of the police and rescue teams.

To make the roadway incident video reporting system of the present disclosure, one may employ the operation of existing or retrofitted dash cams, register user accounts with state DMVs, and configuration settings and permissions on the DMV user site, such that users will be able to capture video during road travel, and when an incident arises, file a roadway incident report and upload the corresponding video (from memory stick or memory device) to the DMV site. In some embodiments, the dash cameras may be registered with the state DMV for authentication purposes. An example of a way to register a dash camera is to register a unique identifier of the camera, such as a MAC address. This way, any video received from a driver can be traced back to an originating dash camera which captured the video. Dash cameras that are installed by the original vehicle manufacturer can further configure a media family identification scheme, such that any media device used in the vehicle can be identified and traced. For instance, the unique identifiers of two dash cams (each with its own unique identifier) and a memory device can be coupled to a unique identifier associated with the actual vehicle (e.g., the VIN number of the vehicle). This chain of devices and vehicle identification enhances the ability of the roadway incident video reporting system to accurately report dangerous roadway incidents that are able to be fully supported by video captured from dash cameras that can be examined for authenticity. Similarly, retrofit installations of dash cameras and/or memory stick/memory devices can also provide authenticating identification information.

In some embodiments, when the two dash cameras are built-in (original vehicle manufacturer installed), additional equipment may enhance the function of the system. For instance, the two built-in dash cameras may fit within protection guard assemblies, with one protection guard assembly for the front of the car and another protection guard assembly for the back of the car. In some embodiments, power cables, data communication cables, and/or video transfer cables extend from the dash cameras to a power source of the vehicle. The memory stick or memory device can be a removable memory stick at the front dashboard of the vehicle or connected to the dash camera, or may be a fixed installation of a memory device which can be accessed by data communication cable from a computing device (e.g., a USB cable). In some embodiments, the memory stick or memory device is associated with a dash display that provides configurable data transfer options, such that captured videos can be dumped from both cameras into the memory, or captured video from one selected camera can be dumped into the memory. In some embodiments, the dash may include logical slots to this memory stick in two portion one front camera video data and another back camera video data.

In some embodiments, the dash display can further be configured to output several video and/or memory indicators or warnings. For instance, the dash display may provide a warning to indicate when the memory is close to its limit, or may provide options for a user to interact with the dash display (e.g., touch screen display) to refresh the memory stick or memory device as soon as it gets filled up to max capacity. In some embodiments, the memory stick or memory device itself can be configured to automatically write over old captured video as soon as a memory storage limit is met. In some embodiments, the video data captured by the dash cameras is saved to the memory device but is contemporaneously uploaded to the subscriber account of the host cloud service. For example, the vehicle or device(s) include internal 4G wireless data connectivity that allows for automatic transfer of video data to the cloud service, thereby eliminating the concern of reaching capacity of the memory device when the memory device is automatically refreshed.

In some embodiments, original vehicle manufactures provide a sub-system which enables owners of vehicles it has manufactured to use the roadway incident video reporting system to capture video of roadway incidents, to provide an incident report and corresponding video to the original vehicle manufacturer to process for video size requirements of the DMV and to limit frivolous submissions of speculative roadway incidents. In such a system, the subsystems of the original vehicle manufacturers may connect to the state DMV to centralize all incident reports with properly supportive video and factually relevant details of legitimate roadway incidents.

In some embodiments, the dash cameras and the memory stick/memory device may communicate with a server over Wi-Fi, 3G, 4G, 5G, etc., such that a vehicle would make a single connection to one cloud portal of DMV and dump all video recording in it which all cars saved.

### III. Roadway Incident Video Capturing and Reporting System

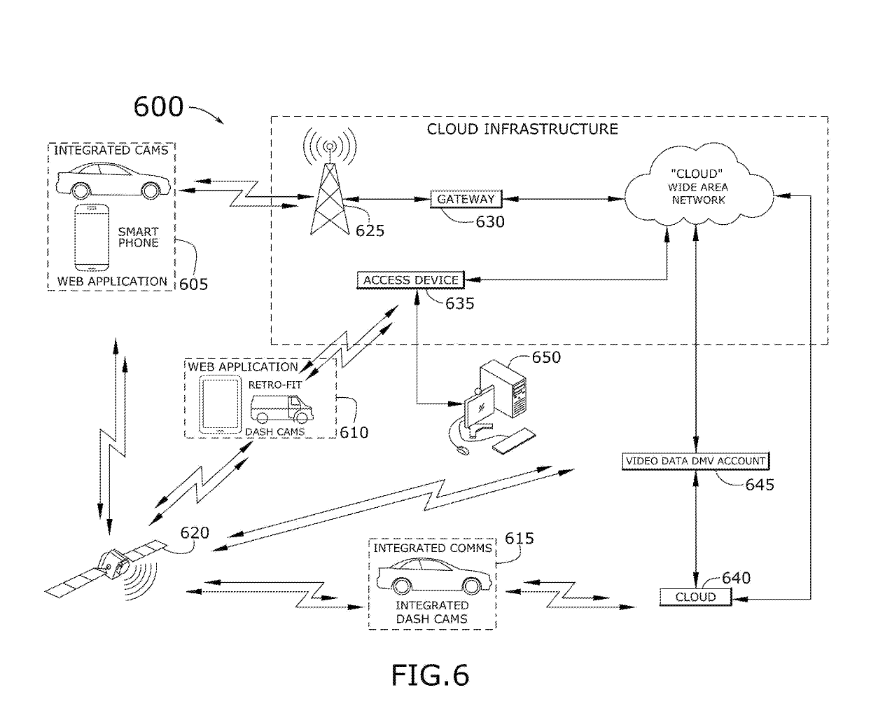

By way of example, FIG. 6 conceptually illustrates a network architecture of a roadway incident video capturing and reporting system 600. As shown in this figure, the roadway incident video capturing and reporting system 600 includes a first automobile hardware camera system 605 associated with first vehicle (i.e., a passenger car), a second automobile hardware camera system 610 associated with a second vehicle (i.e., a van), and a third automobile hardware camera system 615 associated with a third vehicle (i.e., a communication-ready passenger car). The roadway incident video capturing and reporting system 600 also includes a GPS satellite 620 that provides real-time location information to the first, second, and third automobile hardware camera systems 605, 610, and 615 of the first, second, and third vehicles. The real-time location information is associated with video data captured by the cameras associated with the first, second, and third automobile hardware camera systems 605, 610, and 615. The roadway incident video capturing and reporting system 600 also includes a communication tower 625, a gateway 630, and an access device 635 used to communicate over the cloud (wide area network) with a roadway incident video reporting service 640 hosted by a cloud server of a responsible entity, such as a Department of Motor Vehicles (DMV) of a state government. However, the roadway incident video reporting service 640 could be hosted on server computers of other responsible parties, such as a third party contracted service provider that works in connection with the DMV, or a car manufacturer which is interested in obtaining roadway incident video data in order to improve the quality and/or safety of the vehicles it manufactures and sells. Also, as noted above, each driver/user may be registered with the DMV and have a video data DMV account 645 in which to upload their video data captured in relation to roadway incidents it wishes to report.

The first automobile hardware camera system 605 is connected by video cables to the front and rear dash cameras, which in the first vehicle are integrated (factory-installed dash cameras) into the vehicle. A smart phone mobile device is shown in the dashed box surrounding the first automobile hardware camera system 605, indicating that the driver of the first vehicle has a smart phone with the web application installed to access the DMV hosted roadway incident video reporting cloud service 640, thereby allowing an alternative to capture video data and automatically transmit the video data to the roadway incident video reporting cloud service 640. In some embodiments, the first automobile hardware camera system 605 includes internal/embedded wireless connectivity devices (such as 4G connectivity). In these embodiments, the 4G connectivity provides automatic connection to the roadway incident video reporting cloud service 640 such that video data is captured and contemporaneously transferred to the roadway incident video reporting cloud service 640. In some other embodiments, the web application can be configured to connect to the first automobile hardware camera system 605 via a wireless connection, such as Bluetooth, and when connected, to retrieve the captured video data and transfer to the roadway incident video reporting cloud service 640. Thus, after the dash cameras capture video data and the first automobile hardware camera system 605 stores the video data locally on the removable memory storage device, and the 4G connectivity device or the web application retrieves the video data and starts to transfer the video data to the roadway incident video reporting cloud service 640. In connecting to the roadway incident video reporting cloud service 640, the web application uses the smart phone to connect to the communication tower 625, which then passes data to the gateway 630 and through the cloud to the roadway incident video reporting cloud service 640. Authentication of the driver's account (subscriber account) may be automatic, and allows the roadway incident video reporting cloud service 640 to receive the video data from the first vehicle and save it in the authenticated driver's video data DMV account 645 (or subscriber account for any entity hosting the cloud service 640, such as a vehicle manufacturer, etc.).

The second automobile hardware camera system 610 is connected by video cables to retro-fit front and rear dash cameras. Unlike the factory-installed integrated dash cameras of the first vehicle, the retro-fit dash cameras of the second car have been installed after market (i.e., after sale of the second vehicle, the retro-fit dash cameras were purchased and installed into the vehicle). A tablet computing device is shown in the dashed box surrounding the second automobile hardware camera system 610, indicating that the driver of the second vehicle has a tablet computing device with the web application installed to access the DMV hosted roadway incident video reporting cloud service 640, in a manner similar to the way the first automobile hardware camera system 605 worked. However, it is possible that the driver of the second vehicle has configured the second automobile hardware camera system 610 to simply retrieve and store the captured video data, with no intention of automatically uploading the video data to the video data DMV account 645 of the second vehicle driver via roadway incident video reporting cloud service 640. In such case, the driver of the second vehicle may choose to manually provide video data to the DMV later. For instance, after the driver is done traveling, he or she may remove the removable memory storage device and attach it to a computing device outside of the second vehicle, such as stationary desktop computer 650, which connects to the cloud via access device 635, and subsequently connects to the roadway incident video reporting cloud service 640 to upload and store the video data in the second vehicle driver's video data DMV account 645. Alternatively, the driver of the second vehicle may use the tablet computing device to upload and store the video data, since the web application on the tablet computing device may have automatically retrieved the video data with the intention of holding it until the driver connects to a WiFi or other wireless connection (e.g., 4G data connection) outside of the second vehicle. Either way, the driver of the second vehicle (or the drivers of the other vehicles) have options at their disposal for configuring the automobile hardware camera system to work in the way that best suits their needs and constraints. Yet another option is when the driver of the second vehicle may capture video data by using the on-board camera of the tablet computing device with the web application installed, thereby allowing for automatic storage (locally) and transfer to the roadway incident video reporting cloud service 640.

The third automobile hardware camera system 615 is connected by video cables to dash cameras that are fully integrated with the vehicle and with an internal vehicle communication system. In some embodiments, the vehicle communication system is integrally related to the roadway incident video reporting cloud service 640. For example, a manufacturer of the third vehicle may host their own roadway incident video reporting cloud service 640 in which the cloud service 640 receives video data from automobile hardware camera systems that are factory installed in their vehicles and stores the video data in separate video data accounts 645 of the vehicle owners. In some cases, the DMV can be a party in such a system, where the manufacturer provides relevant video data associated with important roadway incidents to the DMV, but also uses all the video data is receives for safety and vehicle usability improvements.

While the example roadway incident video capturing and reporting system 600 described above by reference to FIG. 6 allows for capturing and saving roadway incident video data and providing relevant video data for important roadway incidents to the DMV via a cloud service, a person skilled in the relevant art would understand there to be other types of communication options that can provide such roadway incident video capturing and reporting under real-time and/or time-delayed conditions. For example, instead of a vehicle-based system, a pedestrian, such as a jogger or a person walking through a busy intersection, could utilize the features of the system with small form factor cameras (e.g., smart glasses cameras, smart watch embedded video capture devices, etc.) to obtain roadway and/or walkway incident video data. Furthermore, many of the examples and descriptions above refer to DMV hosted site, DMV cloud service, web application for the DMV site, and other references to the DMV. While reporting roadway incidents to the DMV is an objective of these descriptions and examples, a person skilled in the relevant art would appreciate that the invention can be adapted for use in ways to support any vehicle reporting system associated with any cloud service provider. For example, a car manufacturer may have an interest in obtaining video data from drivers of vehicles manufactured by the car manufacturer, or a third party entity may be designated to deploy and host a roadway incident video data reporting cloud service in connection with the DMV, or other entities in need of video data captured from dash cameras and/or mobile devices and provided by subscription or agreement by drivers of vehicles, etc. Therefore, the above-described embodiments of the roadway incident video capturing and reporting system are presented for purposes of illustration and not of limitation.

### IV. Electronic System

In this specification, the term “software” is meant to include firmware residing in read-only memory or applications stored in magnetic storage, which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the invention. In some embodiments, the software programs, when installed to operate on one or more electronic systems, define one or more specific machine implementations that execute and perform the operations of the software programs.

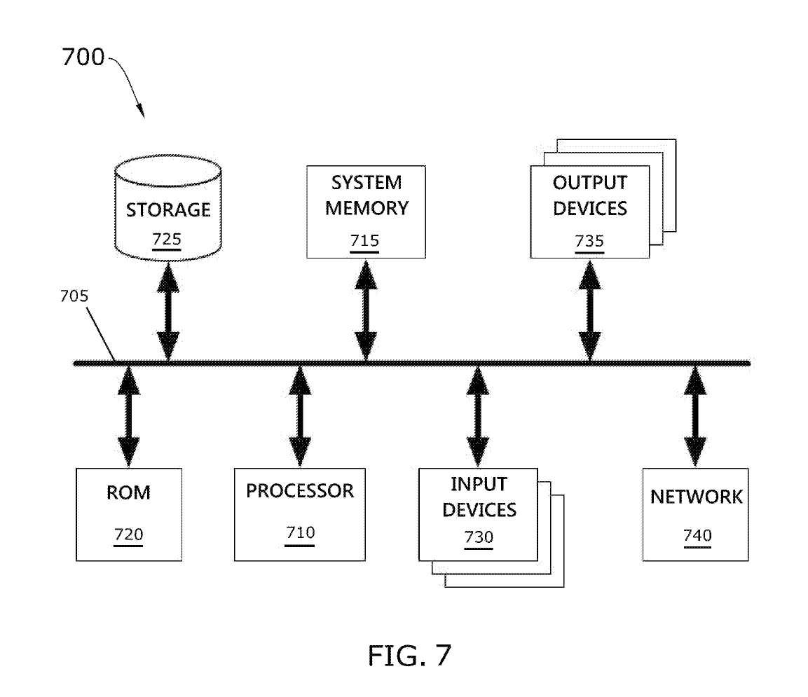

FIG. 7 conceptually illustrates an electronic system 700 with which some embodiments of the invention are implemented. The electronic system 700 may be a computer, phone, PDA, in-car computer, tablet computing device, smartphone mobile device, or any other sort of electronic device. Such an electronic system includes various types of computer readable media and interfaces for various other types of computer readable media. Electronic system 700 includes a bus 705, processing unit(s) 710, a system memory 715, a read-only 720, a permanent storage device 725, input devices 730, output devices 735, and a network 740.

The bus 705 collectively represents all system, peripheral, and chipset buses that communicatively connect the numerous internal devices of the electronic system 700. For instance, the bus 705 communicatively connects the processing unit(s) 710 with the read-only 720, the system memory 715, and the permanent storage device 725.

From these various memory units, the processing unit(s) 710 retrieves instructions to execute and data to process in order to execute the processes of the invention. The processing unit(s) may be a single processor or a multi-core processor in different embodiments.

The read-only-memory (ROM) 720 stores static data and instructions that are needed by the processing unit(s) 710 and other modules of the electronic system. The permanent storage device 725, on the other hand, is a read-and-write memory device. This device is a non-volatile memory unit that stores instructions and data even when the electronic system 700 is off. Some embodiments of the invention use a mass-storage device (such as a magnetic or optical disk and its corresponding disk drive) as the permanent storage device 725.

Other embodiments use a removable storage device (such as a floppy disk or a flash drive) as the permanent storage device 725. Like the permanent storage device 725, the system memory 715 is a read-and-write memory device. However, unlike storage device 725, the system memory 715 is a volatile read-and-write memory, such as a random access memory. The system memory 715 stores some of the instructions and data that the processor needs at runtime. In some embodiments, the invention's processes are stored in the system memory 715, the permanent storage device 725, and/or the read-only 720. For example, the various memory units include instructions for processing appearance alterations of displayable characters in accordance with some embodiments. From these various memory units, the processing unit(s) 710 retrieves instructions to execute and data to process in order to execute the processes of some embodiments.

The bus 705 also connects to the input and output devices 730 and 735. The input devices enable the user to communicate information and select commands to the electronic system. The input devices 730 include alphanumeric keyboards and pointing devices (also called “cursor control devices”). The output devices 735 display images generated by the electronic system 700. The output devices 735 include printers and display devices, such as cathode ray tubes (CRT) or liquid crystal displays (LCD). Some embodiments include devices such as a touchscreen that functions as both input and output devices.

Finally, as shown in FIG. 7, bus 705 also couples electronic system 700 to a network 740 through a network adapter (not shown). In this manner, the computer can be a part of a network of computers (such as a local area network (“LAN”), a wide area network (“WAN”), or an intranet), or a network of networks (such as the Internet). Any or all components of electronic system 700 may be used in conjunction with the invention.

These functions described above can be implemented in digital electronic circuitry, in computer software, firmware or hardware. The techniques can be implemented using one or more computer program products. Programmable processors and computers can be packaged or included in mobile devices. The processes may be performed by one or more programmable processors and by one or more set of programmable logic circuitry. General and special purpose computing and storage devices can be interconnected through communication networks.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the invention has been described with reference to numerous specific details, one of ordinary skill in the art will recognize that the invention can be embodied in other specific forms without departing from the spirit of the invention. For instance, FIGS. 1 and 2 conceptually illustrates processes. The specific operations of each process may not be performed in the exact order shown and described. Specific operations may not be performed in one continuous series of operations, and different specific operations may be performed in different embodiments. Furthermore, each process could be implemented using several sub-processes, or as part of a larger macro process. Thus, one of ordinary skill in the art would understand that the invention is not to be limited by the foregoing illustrative details, but rather is to be defined by the appended claims.

I claim:

1. A roadway incident video capturing and reporting system comprising:
a front dash camera of a vehicle that is configured to capture video out the front of the vehicle while the vehicle is operating;
a back dash camera of the vehicle that is configured to capture video out the back of the vehicle while the vehicle is operating;
a SIM card slot into which a 4G wireless data connectivity SIM card can be installed to provide 4G wireless connectivity;
a memory stick that is configured to store video captured by the front dash camera and the back dash camera; and
a roadway incident reporting system of a department of motor vehicles (DMV) that provides a service for valid drivers to file a roadway incident report and provide corresponding video of the roadway incident.

2. The roadway incident video capturing and reporting system of claim 1, wherein each of the front dash camera and the back dash camera is a factory installed dash camera integrated within the vehicle as manufactured by a manufacturer of the vehicle.

3. The roadway incident video capturing and reporting system of claim 1, wherein each of the front dash camera and the back dash camera is an after market dash camera installed in the vehicle after manufacture of the vehicle.

4. The roadway incident video capturing and reporting system of claim 1, wherein the front dash camera is a factory installed dash camera integrated within the vehicle as manufactured by a manufacturer of the vehicle and the back dash camera is an after market dash camera installed in the vehicle after manufacture of the vehicle.

5. The roadway incident video capturing and reporting system of claim 1, wherein the back dash camera is a factory installed dash camera integrated within the vehicle as manufactured by a manufacturer of the vehicle and the front dash camera is an after market dash camera installed in the vehicle after manufacture of the vehicle.

6. The roadway incident video capturing and reporting system of claim 1 further comprising a web application that is configured to run on a computing device to facilitate transmitting video data captured by the front dash camera the back dash camera to the roadway incident reporting system and saving the transmitted video data in a subscriber account associated with a driver of the vehicle.

7. The roadway incident video capturing and reporting system of claim 6, wherein the web application comprises a mobile application, wherein the computing device comprises a mobile device that includes a mobile processing unit on which the mobile application runs to facilitate transmitting video data captured by the front dash camera the back dash camera to the roadway incident reporting system and saving the transmitted video data in the subscriber account.

8. The roadway incident video capturing and reporting system of claim 6, wherein the web application is further configured to provide a set of tools for filtering the video data saved in the subscriber account.

9. The roadway incident video capturing and reporting system of claim 8, wherein the set of tools for filtering the video data saved in the subscriber accounts ensures that relevant video data is filtered and saved as important roadway incident video data to submit to the DMV for review.

10. The roadway incident video capturing and reporting system of claim 9, wherein the relevant video data comprises a subset of the captured video data.

11. The roadway incident video capturing and reporting system of claim 1, wherein the roadway incident reporting system of the department of motor vehicles (DMV) includes a video data DMV account for each valid driver who uses the service to upload video data associated with roadway incidents.
